(19) United States
(12) Patent Application Publication
(10) Pub. No.: US 2011/0115322 A1
(43) Pub. Date: May 19, 2011

(54) MOTOR REAR COVER

(75) Inventors: Meng-Chiu Yu, Taichung City (TW); Su-Chen Liao, Taichung City (TW)

(73) Assignee: TAIWAN LONG HAWN ENTERPRISE CO., Taichung City (TW)

(21) Appl. No.: 12/622,027

(22) Filed: Nov. 19, 2009

(51) Int. Cl. H02K 5/15; H02K 5/14

(52) U.S. Cl. 310/89; 310/239

(57) ABSTRACT

The present invention relates to a motor rear case, which is mounted on a motor case with a connecting bore. The motor rear case includes a main body and a plurality of protrusions. The main body has an annular plug, on which the protrusions are provided. The annular plug is inserted into the connecting bore and the protrusions make an interference fitness that provides a firm connection between the motor rear cover and the motor case.

### BACKGROUND OF THE INVENTION

1. Field of the Invention

The present invention relates generally to a motor, and more particularly, to a rear cover mounted to the motor.

2. Description of the Related Art

A conventional motor includes a case, a rotor received in the case, and a rear cover connected to the case to seal the rotor. For assembling such motor, the rotor is put into the case first, and then engaged with an annular plug with a bore of the case to mount the rear cover on the case by screws that a spindle of the rotor passes through the rear cover via a center bore thereof.

Typically, the rear cover is made of plastic with high rigidity and is high heat-resistant. It is made by injection molding such that the annular plug and the center bore are formed in the molding process. Due to thermal expansion of plastic and the difficulty in managing precision of the cavity of the molding, the annular plug 1 is deformed, which means an outline of the plug 1 is not round. When user, as shown in FIG. 1, inserts such plug into the bore 2 of the case, it might break the rear cover. Additionally, the plug may deviate from the desired position because of the injection molding, and also that the plug 1 and the center bore 3 are not concentric, as shown in FIG. 2. As a result, the spindle 1 will be interfered by the center bore 3 when the plug 1 is engaged with the bore 2.

### SUMMARY OF THE INVENTION

The primary objective of the present invention is to provide a motor rear cover, which has a firm structure of connection with the motor case.

According to the objective of the present invention, a motor rear cover, which is connected to a motor case having a connecting bore, includes a main body and a plurality of protrusions. The main body has an annular plug, on which the protrusions are provided. The annular plug is inserted into the connecting bore and the protrusions will press a sidewall of the connecting bore.

In addition, diameter of the annular plug is slightly smaller than that of the connecting bore.

### BRIEF DESCRIPTION OF THE DRAWINGS

FIG. 1 is a sketch diagram of conventional motor, showing a problem of connection between the case and the rear cover;

FIG. 2 is a sketch diagram of conventional motor, showing another problem of connection between the case and the rear cover;

FIG. 3 is a perspective view of the motor rear cover and the motor case of a preferred embodiment of the present invention;

FIG. 4 is a perspective view of the motor rear cover of the preferred embodiment of the present invention;

FIG. 5 is a sketch diagram of preferred embodiment of the present invention, showing motor rear cover and the motor case before connection;

FIG. 6 is a sketch diagram of preferred embodiment of the present invention, showing motor rear cover and the motor case after connection.

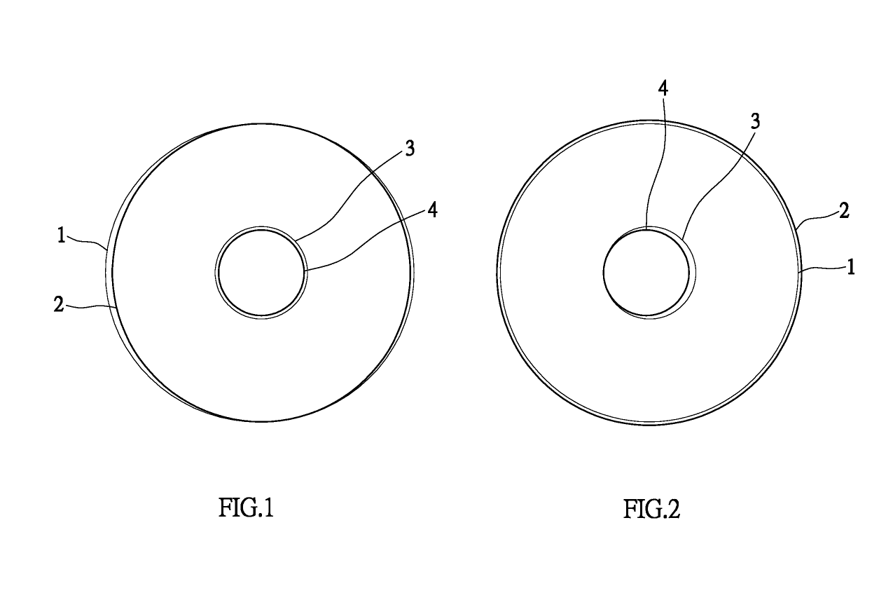

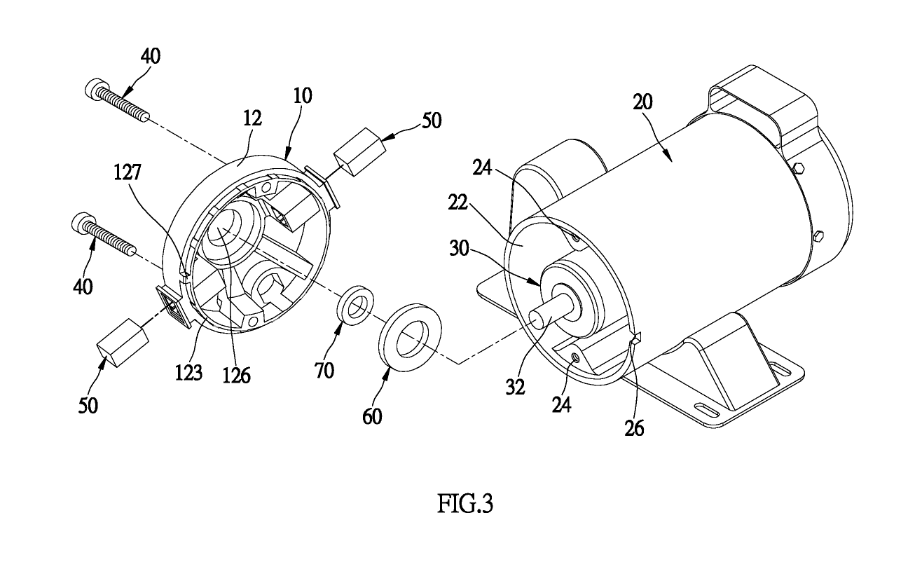

### DETAILED DESCRIPTION OF THE INVENTION

FIG. 3 shows a motor rear cover 10 of the preferred embodiment of the present invention, which is connected to a motor case 20 having a connecting bore 22, two threaded bores 24, and a positioning bore 26. The motor case 20 is received with a rotor 30 having a spindle 32 therein.

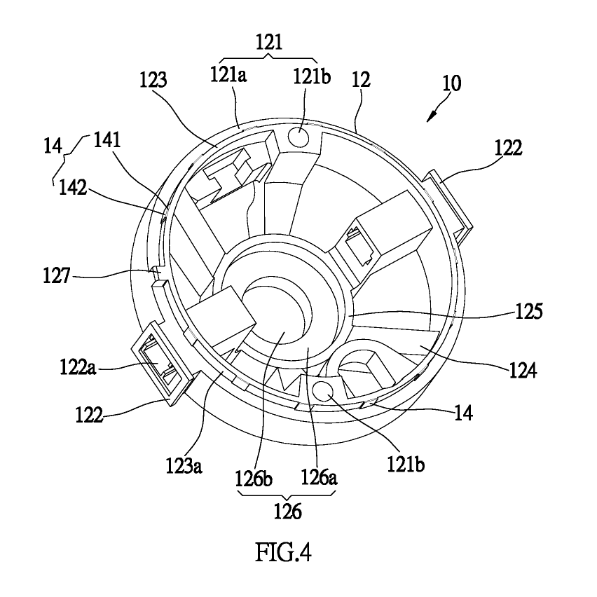

As shown in FIG. 4, the motor rear cover 10 has a round main body 12 and plural of protrusions 14 on the main body 12. The main body 12 includes an annular rim 121, two carbon brush bases 122, an annular plug 123, a plural of ribs, a spindle base 125, and a positioning block 127.

The annular rim 121 has a top face 121a and two bores 121b. Two bolts 40 may be inserted into the bores 121b and screwed into the threaded bores 24 of the motor case 20 to secure the main body 12 to the motor case 20.

The carbon brush bases 122 are symmetric and each has a recess 122a to receive a carbon brush 50 therein.

The annular plug 123 is axially projected from the top face 121a of the annular rim 121. As shown in FIG. 5, the annular plug 123 has a circumference 123a, whose diameter is slightly smaller than that of the connecting bore 22 of the motor case 20.

The ribs 124 connect the annular rim 121 and the spindle base 125 to provide a stronger structure.

The spindle base 125 has a round bore 126, which has a big-diameter section 126a and a small-diameter section 126b to receive a first bearing 60 and a second bearing 70 therein that the spindle 30 passes through the first bearing 60 and the second bearing 70.

The positioning block 127 is on the top face 121a of the annular rim 121.

The protrusions 14 are on the circumference 123a of the annular plug 123 with a constant interval therebetween. Each of the protrusions 14 has a block 142 and a tapered portion 141 at a front end of the block 142. As shown in FIG. 5, a periphery S constructed by tops of the protrusions 14 is slightly greater than the connecting bore 22.

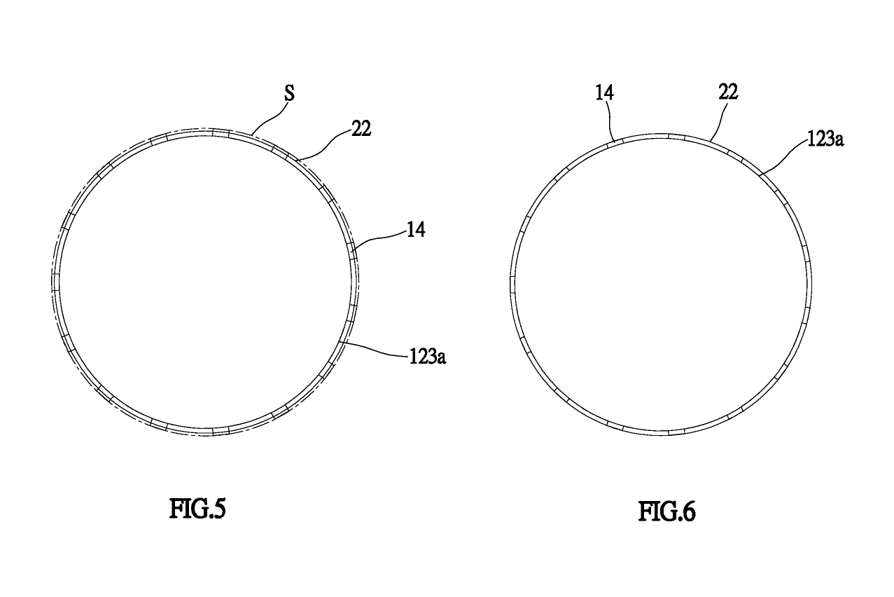

Before assembling the motor rear cover 10 and the motor case 20, the rotor 30 is put in the motor case 20. Next, align the positioning block 127 of the motor rear cover 10 with the positioning bore 26 of the motor case 20, and then align the annular plug 123 with the connecting bore 22. In engagement of the annular plug 123 and the connecting bore 26, the tapered portions 141 of the protrusions 14 guide the annular plug 123 to a desired position. Following, exert the motor rear cover 10 to force the annular plug 123 entering the connecting bore 22 that the annular plug 123 is fit to the connecting bore 22 in interference fitness because of the protrusions 14. Even if the connecting bore 22 or the protrusion 142 is deformed or deviated, it will not affect the interference fitness of the annular plug 123 and the connecting bore 22, as shown in FIG. 6. At last, the bolts 40 secure the motor rear cover 10 and the motor case 20.

The description above is a few preferred embodiments of the present invention. Those equivalences of the present invention are still in the scope of claim construction of the present invention.

What is claimed is:

1. A motor rear cover, which is connected to a motor case having a connecting bore, comprising:
a main body having an annular plug; and
a plurality of protrusion on a circumference of the annular plug that the protrusions presses a sidewall of the connecting bore of the motor case when the annular plug is inserted into the connecting bore.

2. The motor rear cover as defined in claim 1, wherein a diameter of the annular plug is smaller than that of the connecting bore.

3. The motor rear cover as defined in claim 1, wherein the main body and the protrusions are a single unity.

4. The motor rear cover as defined in claim 1, wherein the main body has two bores for two bolts to insert and be screwed into the motor case.

5. The motor rear cover as defined in claim 1, wherein the main body has an annular rim, from a top face of which the annular plug is axially projected, and two carbon brush bases on the annular rim to receive carbon brushes.

6. The motor rear cover as defined in claim 1, wherein each of the protrusions has a block and a tapered portion at a front end of the block.

7. The motor rear cover as defined in claim 1, wherein the main body has a spindle bore at a center thereof for a spindle of a rotor passing therethrough.

8. The motor rear cover as defined in claim 7, wherein the spindle bore has a big-diameter section and a small-diameter section, in each of which a bearing is received.

9. A motor rear cover, which is connected to a motor case having a connecting bore, comprising:
a main body having an annular plug, which has a diameter smaller than that of the connecting bore of the motor case; and
a plurality of protrusion on a circumference of the annular plug that the protrusions press a sidewall of the connecting bore of the motor case when the annular plug is inserted into the connecting bore.
